(19) United States
(12) Patent Application Publication
(10) Pub. No.: US 2004/0030273 A1
(43) Pub. Date: Feb. 12, 2004

(54) Programmed vibrating device using electro-luminescent readout

(76) Inventor: Martin Tucker, Encino, CA (US)

Correspondence Address: OPPENHEIMER WOLFF & DONNELLY LLP, Suite 3800, 2029 Century Park East, Los Angeles, CA, 90067-3024, US

(21) Appl. No.: 10/214,411

(22) Filed: Aug. 6, 2002

(51) Int. Cl. A61H 23/02

(52) U.S. Cl. 601/70; 601/72

(57) ABSTRACT

A circuit in a hand held controller operatively connects to the internal vibrator. The controller adjusts the frequency and amplitude of the vibrator's vibrations. A display of electroluminescent elements in an array on the controller displays the state of the controller. The controller provides several programs of different frequencies or amplitudes or changes of the frequencies or amplitudes over time. As the user changes the program using buttons on the controller, the circuit changes the program and illuminates the electroluminescent element corresponding to the program.

### BACKGROUND OF THE INVENTION

1. Field of the Invention

The present invention is a vibrator with a controller that allows the user to change programs for the frequency, amplitude and changes over time to the frequency and amplitude. A display shows which program is active.

2. General Background and State of the Art

Many devices intentionally vibrate. Examples of vibrating devices include the brush portion of electric toothbrushes. It vibrates so that the bristles move rapidly along the teeth and gums. Likewise, massagers vibrate parts that are in contact with a person's skin or clothing. The pulses relax adjacent muscles and feel good. Some vibrating devices supply vibrations to body parts that are subject to sexual stimulation. The vibrations can cause or increase arousal.

Users may want to adjust vibrations of some vibrating devices, but other commercial products may operate at one speed. Electric toothbrushes typically have one speed (frequency) and one amplitude. Vibrators, however, often are adjustable.

Some users may want slow but deep vibrations (low frequency and high amplitude). Other user or the same user at another time may want higher frequency and lower amplitude vibrations. Of course, other users may want different combinations of frequency and amplitude. In addition, some users may want the vibrations to cycle over time, changing from a higher to a lower frequency and then back to the higher frequency as the amplitude either changes or stays the same. Each of these variables can be a separate program.

A display showing which program is active also is useful especially because some people use vibrators in the dark. Adjusting a vibrator in the dark can be difficult. Though the user does not necessarily have to see buttons or knobs to adjust the frequency or amplitude, he or she may not be able to tell in the dark what pushing a button or turning a knob will do. One can illuminate the button or knob, but most illumination devices consume electricity, which takes useful life from a battery-operated vibrator.

Electroluminescence can be a source of illumination. Electroluminescence converts electrical energy into light energy directly without heat. Most such devices are special semiconductors. When an electrical field passes through the semiconductor, it generates electroluminescence. Electroluminescent devices often generate dim light, but that light is sufficient for many applications. The light also is cool to the touch so it will not burn. It also is very efficient and uses little power. This latter attribute is important for battery-operated device such as battery vibrators.

### INVENTION SUMMARY

One object or the present invention is to provide a vibrating device that is programmable and that a user can see through a display which program is running. Another object of the present invention is to have an illuminated display that uses electroluminescence. These and other object are evident from the detailed description of the exemplary embodiments and the drawings.

A vibrating device of the present invention includes a vibrator housing and an internal vibrator mounted and vibrating within the housing. A controller operatively connects to the internal vibrator. The controller adjusts the frequency and amplitude of the vibrator's vibrations. A display comprising an array of electroluminescent elements on the controller displays the state of the controller. The controller provides several programs of different frequencies or amplitudes or changes of the frequencies or amplitudes over time. In one embodiment, the display has a separate lighted area for each program that are selectively illuminated by electroluminescent elements. Buttons or other actuators on the controller allow the user to change between different programs. As the programs change, the lighted area associated with the chosen program illuminates.

### BRIEF DESCRIPTION OF THE DRAWINGS

FIG. 1 is a top view of the controller of the present invention attached by a cable to a vibrating element.

FIGS. 2, 3 and 4 are respectively perspective, bottom and side views of the controller.

### DETAILED DESCRIPTION OF THE PREFERRED EMBODIMENTS

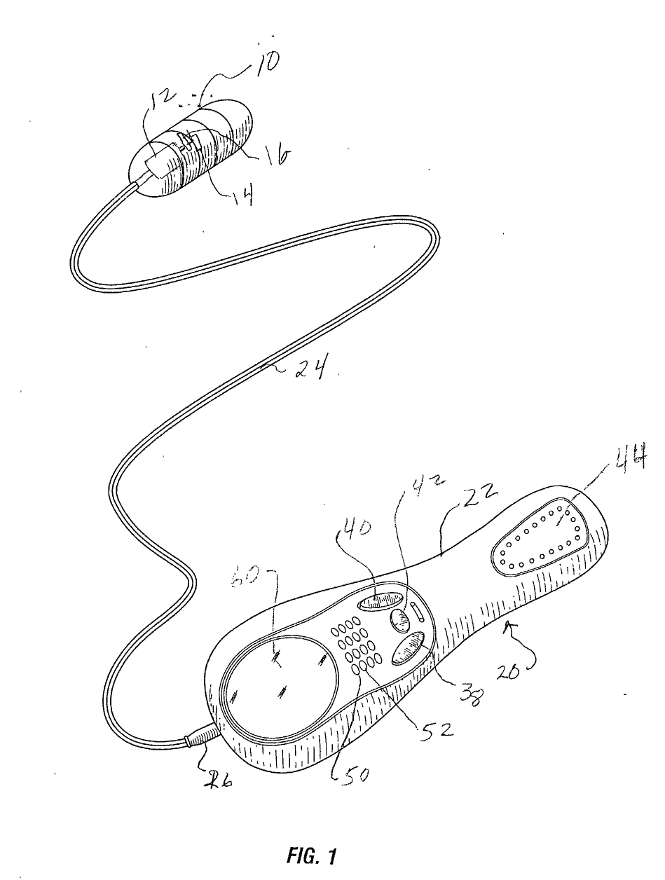

The vibrating device of the present invention includes a vibrator housing 10 (FIG. 1). In the exemplary embodiment, the vibrator includes a small electric motor 12 mounts within the housing and rotates eccentrics 14 and 16 in opposite directions when the motor is activated. When the eccentrics rotate, the vibrator housings vibrate. Changes in the motor's rotational speed change the vibration frequency, and changing the positions of the eccentrics relative to each other changes the amplitude of the vibrations. The exemplary embodiment uses rotating eccentrics to cause vibrations, but reciprocating and other vibrators also can be used.

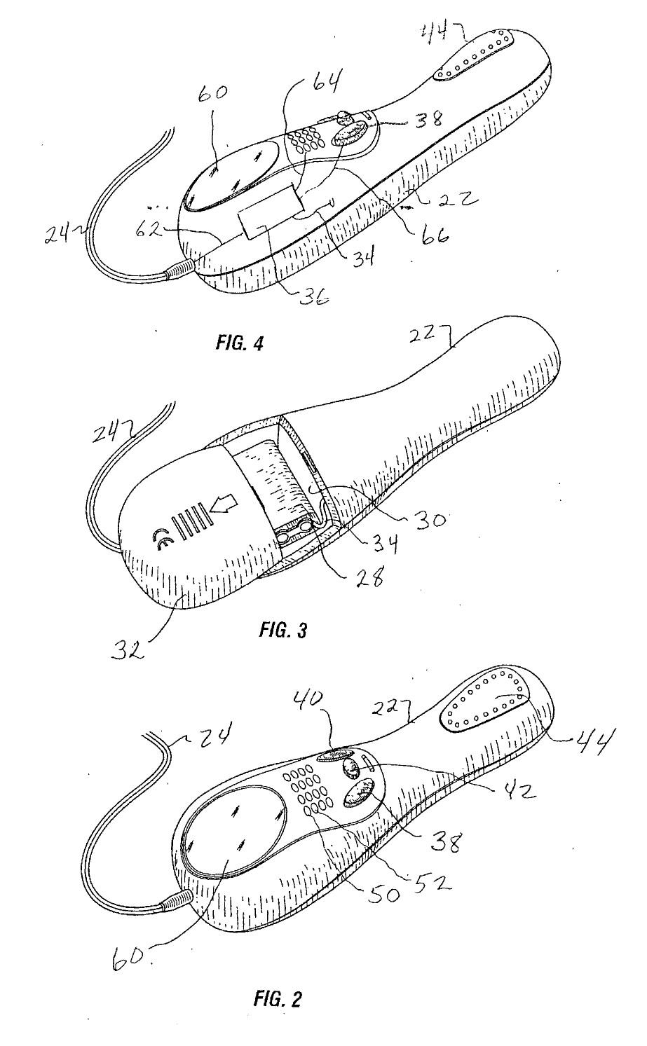

A controller operatively connects to the vibrator. In the exemplary embodiment, the controller 20 is a separate unit mounted within controller housing 22 (FIGS. 1-4) that attaches to the vibrator housing 1 by a cable 24. However, the vibrator (i.e., motor 12 and eccentrics 14 and 16) may be mounted in the controller housing 22. Controller housing 22 is shaped so that it can be hand held. The display portion (on the left side of FIG. 1) is wider to leave more room for a display. Having the vibrator housing 10 and the controller housing 22 separate allows the user to position the controller where he or she can see it and to position the vibrator housing 10 at a different position.

Cable 24 may permanently attach to the vibrator housing 10 and the controller housing 22, but in the exemplary embodiment, an electric plug 26 on the left end (FIG. 1) of the controller housing plugs into a receptacle (not shown) in the controller housing 22. Though the cable also could plug into the vibrator housing, it is permanently attached in the exemplary embodiment.

A battery 28 mounts in a cavity 30 in the bottom of the controller housing 22 (FIG. 3). Cover 32 slides off the controller housing for access to the battery and slides over the battery to secure the battery in place. Cable 34 electrically connects the battery to controller circuit 36 (also shown schematically in FIG. 4).

The controller circuit adjusts the frequency and amplitude of the vibrator's vibrations. In the exemplary embodiment, controller circuit 36 affects those changes. On/off switch 42 on the controller activates the circuit that, in turn, signals vibrator motor 12 though conductor(s) 62 and cable 24 (FIG. 4). In the exemplary embodiment, when the on/off switch is turned “on,” the vibrator operates at the same program that it operated when the switch had been turned “off.” The circuit could also have an initial program at which it always starts, or the first program upon turning the switch “on” could be randomized.

Many potential programs are possible. For example, program 1 could have low frequency and low amplitude. Program 2 could be high frequency and high amplitude. Program 3 could be high frequency and low amplitude, and program 4 could be low frequency and high amplitude. The frequency and amplitude of programs 1 though 4 would remain constant over time. There could be additional, similar programs for medium frequencies and amplitudes.

The remaining programs would change frequency or amplitude or both over time in varying combinations. The rate of change of the frequency or amplitude could change over time and varying rates. For example, the frequency of program 5 could remain constant at a low frequency while the amplitude slowly increases, decreases and repeats. Program 6 would be similar to program 5, but the rate of change of the amplitude would be different. Other programs would vary the frequency while holding the amplitude constant. Still others would simultaneously vary the frequency and amplitude over different rates of change.

The exemplary embodiment has 16 different programs, but fewer or more programs are possible. In addition, the exact programs that the circuit 36 provides are matters of choice.

Conductor(s) 66 connect buttons 38 and 40 with circuit 46 (FIG. 4). Button 40 changes the program upward in number (i.e., from program 1 to 2 or 2 to 3). Button 42 changes the program down in number (i.e., from program 16 to 15).

So that the user knows what program is active, the present invention provides a display showing the active program. The exemplary embodiment uses an array of 16 regions, e.g., regions 50 and 52. One region is provided for each program. Each region may be provided with a small number to indicate the program.

The circuit illuminates the region corresponding to the program being run by the vibrator. A display of electroluminescent elements illuminates the correct region. For example, region 50 could signal program 1, and region 52 could signal program 5. Conductor 64 connects the electroluminescent elements to circuit 36. As the user pushes one of the buttons 40 or 38, the circuit drives the vibrator motor 12 and the eccentrics through the chosen program. The circuit sends a signal to the electroluminescent element to illuminate the correct region. Thus, by viewing the array of regions and seeing which is illuminated, the user can tell which program is active. Also, at least one region will be illuminated when the user turns the on/off switch “on,” so the display also tells when the unit is on. If the user pushes the on/off switch but no region becomes illuminated, the battery 28 probably needs replacing.

The exemplary embodiment uses one region fur each program, but the pattern of illuminated regions on the array also could show the program in use.

The exemplary embodiment also has another display 60 that could contain the product trademark or operating instructions. Electroluminescent elements could illuminate portions of display 60. Optional plate 44 attaches to the controller housing 22. Though it could provide access into the controller housing, it can also be of a different material than the rest of the housing and be decorative.

While the specification describes particular embodiments of the present invention, those of ordinary skill can devise variations of the present invention without departing from the inventive concept.

We claim:

1. A vibrating device comprising:
a) a vibrator housing and an internal vibrator mounted and vibrating within the vibrator housing;
b) a controller operatively connected to the internal vibrator; the controller having a circuit that adjusts the frequency and amplitude of the vibrator's vibrations;
c) a display on the controller displaying the state of the controller, wherein the display contains electroluminescent elements.

2. The vibrating device of claim 1 wherein the controller provides at least two programs of different frequencies or amplitudes or changes of the frequencies or amplitudes over time.

3. The vibrating device of claim 2 further comprising a portion of the display on the controller indicating a particular program and an electroluminescent element illuminating a portion of the display to show which program is in operation.

4. The vibrating device of claim 3 further comprising at least one actuator on the controller for changing the program that the controller runs.

5. The vibrating device of claim 1 further comprising at least one actuator on the controller for changing the program that the controller runs.

6. A controller for an electric vibrating device comprising:
a) a controller housing electrically connectable to the vibrating device;
b) a circuit in the controller housing for sending a set of signals of at least two different sets of signals to the vibrating device;
c) an actuator on the controller for changing between sets of signals;
d) a display on the controller, the display having regions, at least one region corresponding to each set of signals, wherein each region of the display is illuminated by an electroluminescent element to illuminate the region corresponding to the set of signals corresponding to the region.

7. The controller of claim 6 wherein the regions of the display are arranged in an array.

8. The controller of claim 7 wherein the actuator comprises two buttons, one button cycling through the programs in one pattern and the other button cycling through the programs in another pattern.
